(19) United States
(12) Patent Application Publication
(10) Pub. No.: US 2018/0252482 A1
(43) Pub. Date: Sep. 6, 2018

(54) INTERCOOLER AND DEVICE FOR DISCHARGING INTERCOOLER CONDENSATE WATER

(71) Applicant: Jin Ho KOO, Dangjin-si (KR)

(72) Inventor: Jin Ho KOO, Dangjin-si (KR)

(21) Appl. No.: 15/972,173

(22) Filed: May 6, 2018

Related U.S. Application Data
(63) Continuation of application No. PCT/KR2016/002544, filed on Mar. 15, 2016.

(30) Foreign Application Priority Data
Nov. 11, 2015 (KR) 10-2015-0158179

(51) Int. Cl. F28F 17/00; F02B 29/04

(52) U.S. Cl. CPC F28F 17/005; F02B 29/0456

(57) ABSTRACT

A compensate water discharger coupled to, or integrally formed with, an intercooler may comprise a man body coupled to a tube of the intercooler and configured to collect compensate water in the tube, a collecting hole formed in an upper part of the main body and configured to provide a path along which the compensate water is collected from the tube to the main body, a discharging door formed in a side of the main body to discharge the compensate water to an outside, and a solenoid valve configured to open or close the discharging door.

### CROSS-REFERENCE TO RELATED APPLICATIONS

This patent application is a continuation of International Patent Application No. PCT/KR2016/002544, filed on Mar. 15, 2016, which claims priority under 35 U.S.C. § 119 to Korean Patent Application No. 10-2015-0158179, filed on Nov. 11, 2015, in the Korean Intellectual Property Office, the disclosure of which is incorporated by reference herein in its entirety.

### TECHNICAL FIELD

Embodiments of the present disclosure concern an intercooler and compensate water discharger attached to, or integrally formed with, the intercooler to discharge compensate water generated as air is compressed by a turbocharger and forced into the combustion engine.

### DISCUSSION OF RELATED ART

A turbocharger, or colloquially turbo, is a turbine-driven forced induction device that increases an internal combustion engine's efficiency and power output by forcing extra air into the combustion chamber.

Since the air forced is reduced in density due to the temperature rise, an intercooler is disposed downstream of the compressor to cool, and raise the density of, the air, thereby enhancing the power output of the engine.

The air compressed by the turbocharger is high-temperature and high-pressure, and if cooled in this state, its temperature and pressure both are lowered, causing the water vapor in the air to condense into water liquid. In particular, adopting lower-pressure loop EGR to turn the exhaust gases back upstream of the compressor eases creation of compensate water.

Compensate water may be accumulated in the lower part of the intercooler by the gravity, causing an output deterioration or engine stop, or corrosion to the engine due to acids contained in the exhaust gases.

In the winter season, compensate water may be frozen to damage the intercooler.

### SUMMARY

According to an embodiment of the present disclosure, a compensate water discharger comprises a man body coupled to a tube of an intercooler and configured to collect compensate water in the tube, a collecting hole formed in an upper part of the main body and configured to provide a path along which the compensate water is collected from the tube to the main body, a discharging door formed in a side of the main body to discharge the compensate water to an outside, and a solenoid valve configured to open or close the discharging door.

The tube of the intercooler may be the lowermost one of a plurality of tubes of the intercooler.

At least one or more scattering rods may be connected to the collecting hole or the upper part of the main body and be positioned inside the tube.

When the air moves from a first side of the collecting hole to a second side of the collecting hole, the at least one or more scattering rods may be positioned closer to the first side of the collecting hole.

A net may be connected to the collecting hole or the upper part of the main body and be positioned inside the tube. The net may include at least one or more vertical rods and at least one or more horizontal rods crossing the at least one or more vertical rods.

The upper part of the main body may have a shape corresponding to a lower part of the tube.

According to an embodiment of the present disclosure, an intercooler for a car comprises a plurality of tubes arranged one over another and a valve formed in a lowermost of the plurality of tubes to open or close, wherein the valve is controlled to open when a brake pedal of the car is operated.

A main body may be coupled to the lowermost tube of the intercooler to collect compensate water passing through the valve.

A first side of the main body may be positioned close to a passenger seat of the car, and a second side of the main body may be positioned close to a driver's seat of the car. The main body may become deeper from the first side to the second side of the main body.

The main body may include a discharging head configured to be moved up or down by the weight of the compensate water, an elastic member configured to move up or down the discharging head, and at least one hole configured to discharge the compensate water as the discharging head descends.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating an engine apparatus of a car according to an embodiment of the present disclosure;

FIGS. 2 and 3 are views illustrating an intercooler according to an embodiment of the present disclosure;

FIG. 4 is a view illustrating an example of coupling a compensate water discharger to a lowermost tube of an intercooler according to an embodiment of the present disclosure;

FIG. 5 is a view illustrating an example in which a compensate water discharger remains coupled to a tube of an intercooler according to an embodiment of the present disclosure;

FIG. 6 is a view illustrating a compensate water discharger with a different shape according to an embodiment of the present disclosure;

FIG. 7 is a view illustrating an example in which a discharging door of a compensate water discharger is positioned given the driver's seat, according to an embodiment of the present disclosure;

FIG. 8 is a block diagram illustrating a method for controlling a discharging door of a compensate water discharger according to an embodiment of the present disclosure;

FIG. 9 is a perspective view illustrating a compensate water discharger according to an embodiment of the present disclosure;

FIG. 10 is a view illustrating an example in which compensate water is scattered by scattering rods to reduce the likelihood of condensation, according to an embodiment of the present disclosure;

FIG. 11 is a view illustrating an example in which scattering rods of a compensate water discharger are provided in different positions according to an embodiment of the present disclosure;

FIGS. 12, 13, and 14 are views illustrating main bodies with various shapes according to embodiments of the present disclosure; and

FIGS. 15, 16, 17, 18, 19, 20, 21, 22, 23, and 24 are views illustrating various examples of collecting compensate water when a main body of a compensate water discharger is formed as part of an intercooler according to embodiments of the present disclosure.

### DETAILED DESCRIPTION OF EXEMPLARY EMBODIMENTS

Hereinafter, exemplary embodiments of the present disclosure will be described in detail with reference to the accompanying drawings. The present disclosure, however, may be modified in various different ways, and should not be construed as limited to the embodiments set forth herein. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

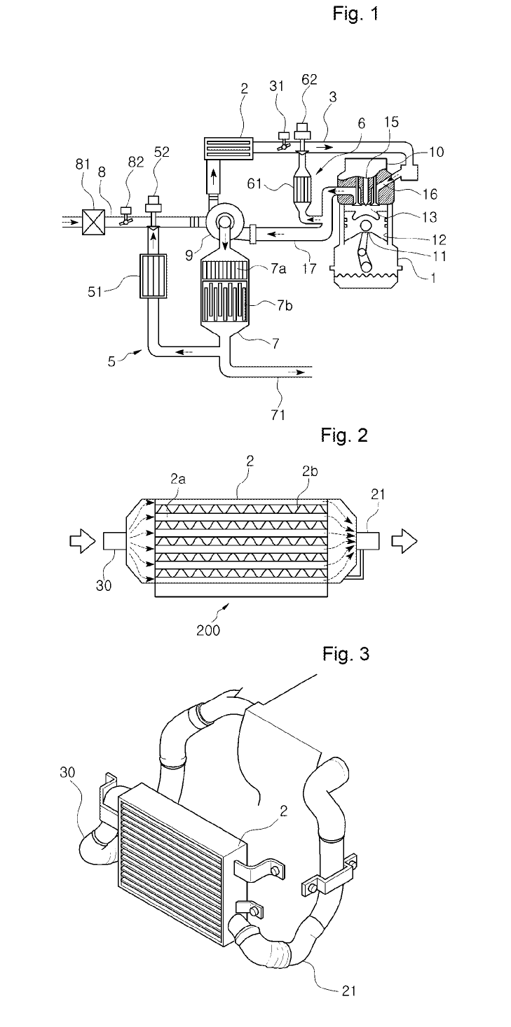

FIG. 1 is a view illustrating an engine apparatus of a car according to an embodiment of the present disclosure.

Referring to FIG. 1, according to an embodiment of the present disclosure, an engine apparatus 100 of a car includes an engine 1, a turbo charger 9 driven by exhaust gases discharged from a combustion chamber 13 of the engine 1 through an exhaust manifold 17, an exhaust gas purifier 7 provided between the turbo charger 9 and an exhaust pipe 71 to purify the exhaust gases from the turbo charger 9, an intercooler 2 cooling the air over supplied by the turbo charger 9, a first intake pipe 3 for introducing the air cooled by the intercooler 2 to the combustion chamber 13 of the engine 1, a second intake pipe 8 for introducing the air from an air cleaner 81, which removes dust from the external air, to the turbo charger 9, a high-pressure loop exhaust gas recirculation (EGR) 6 disposed between the first intake pipe 3 and the exhaust manifold 17, a low-pressure loop EGR 5 disposed downstream of the exhaust gas purifier 7 of the exhaust pipe 71 and on the second intake pipe 8, and a central controller 110 which is an engine control unit (ECU) to control the operation of the engine apparatus 100.

The combustion chamber 13 is a space inside the engine 1 and includes a cylinder 12, a piston 11 sliding up or down along an axis inside the cylinder 12, and a cylinder head 10 closing the cylinder 12.

When the piston 11 reaches top-dead-enter (TDC), a fuel discharge valve 15 is opened to deliver the compressed air-fuel mixture that is then ignited by heat generated by high compression.

The turbo charger 9 compresses the air exhausted from the air cleaner 81 using a compressor disposed on the same axis as an exhaust turbine which is driven by the exhaust gases from the combustion chamber 13 of the engine 1. The compressed air is in a high-temperature state. Thus, the hot, compressed air is cooled down by the intercooler 2 and is then introduced into the combustion chamber 13, thereby allowing the engine 1 an enhanced power output.

The exhaust pipe 71 is connected to the exhaust turbine side of the turbo charger 9 and has the exhaust gas purifier 7. The exhaust gas purifier 7 includes an oxidation catalyst 7a and a particulate filter 7b in the direction along which the exhaust gases flow. The purified gases are discharged to the outside through the exhaust pipe 71.

The high-pressure loop EGR 6 disposed between the first intake pipe 3 and the exhaust manifold 17 includes a high pressure-side EGR cooler 61, a high pressure-side EGR valve 62 adjusting the amount of exhaust gases cooled by the high pressure-side EGR cooler 61 and introduced into the first intake pipe 3, and a second throttle valve 31.

The central controller 110 controls the opening and closing of the high pressure-side EGR valve 62 and the second throttle valve 31.

The high-pressure loop EGR 6 secures the EGR gases introduced into the combustion chamber 13 when the engine 1 is at low load and reduces the amount of oxygen, thereby reducing the combustion temperature in the combustion chamber 13 and resultantly suppressing the generation of NOx.

The high pressure-side EGR cooler 61 may increase the density of the exhaust gases coming into the combustion chamber 13 by cooling down the exhaust gases.

The low-pressure loop EGR 5 disposed between the second intake pipe 8 and the downstream part of the exhaust gas purifier 7 of the exhaust pipe 71 includes a low pressure-side EGR valve 52, which adjusts the amount of the exhaust gases cooled by the low pressure-side EGR cooler 51 and introduced into the second intake pipe 8, and a first throttle valve 82.

The central controller 110 controls the opening and closing of the low pressure-side EGR valve 52 and the first throttle valve 82.

When the engine 1 is subjected to more revolutions and high load, the air pressure inside the first intake pipe 3 rises, causing the influx of an insufficient amount of EGR gases into the first intake pipe 3. The low-pressure loop EGR 5 introduces the EGR gases into the upstream part of the compressor of the turbo charger 9 when the engine 1 works under high load and more revolutions, thereby allowing a sufficient amount of EGR gases to come into the combustion chamber 13.

FIGS. 2 and 3 are views illustrating an intercooler according to an embodiment of the present disclosure.

Referring to FIGS. 2 and 3, air introduced into the intercooler 2 flows from the left (upstream part) to right (downstream part).

The second intake pipe 8 is connected to an inlet 30 of the intercooler 2 to introduce the air compressed by the turbo charger 9, and the first intake pipe 3 is connected to an outlet 21 of the intercooler 2 to introduce the air, cooled and compressed by the intercooler 2, into the combustion chamber 13.

The intercooler 2 includes high heat-conductance, metallic tubes 2a through which the air flows and fins 2b provided along the outer circumferences of the tubes 2a to cool the air.

The air compressed by the turbo charger 9 exchanges heat with the walls of the tubes 2a while passing through the tubes 2a, and the tubes 2a transfer the heat to the fins 2b. The fins 2b are cooled by their contacting external air.

A condensate water discharger 200 may be mounted on the outer circumference of the tubes 2a to collect and discharge condensate water generated when the air flowing through the tubes 2a is compensated. The compensate water discharger 200 may be coupled to a lowermost tube of an existing type of intercooler 2. A predetermined size of discharge hole may be formed in the lowermost tube of the intercooler 2 to discharge compensate water.

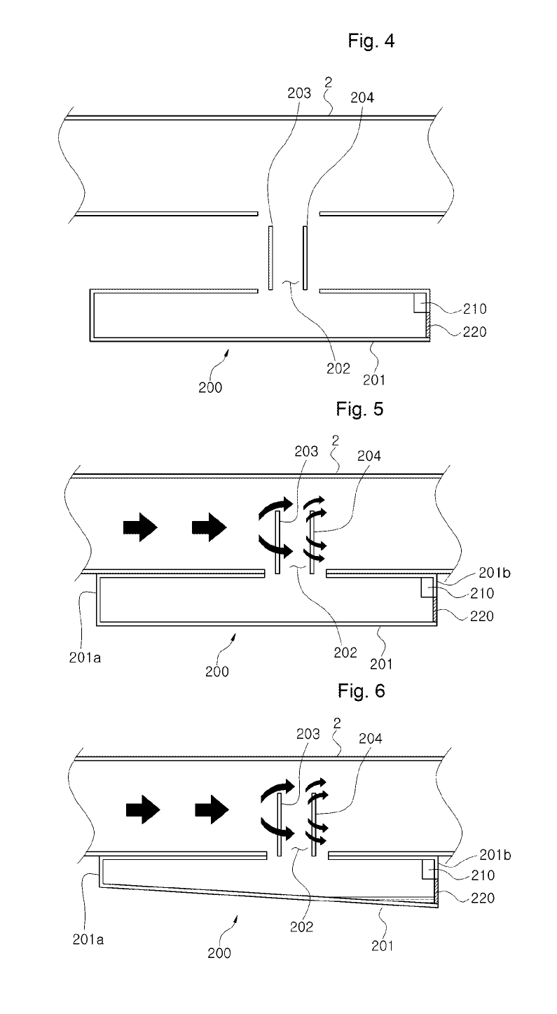

FIG. 4 is a view illustrating an example of coupling a compensate water discharger to a lowermost tube of an intercooler according to an embodiment of the present disclosure. FIG. 5 is a view illustrating an example in which a compensate water discharger remains coupled to a tube of an intercooler according to an embodiment of the present disclosure.

Referring to FIGS. 4 and 5, according to an embodiment of the present disclosure, where a compensate water discharger 200 is mounted onto an existing intercooler 2, a hole sized to enable insertion of scattering rods 203 and 204 is formed in a lower tube of the intercooler 2.

The scattering rods 203 and 204 are inserted into the hole in the tube, and the intercooler 2 is fastened to the top of the compensate water discharger by, e.g., wending or attaching.

The compensate water discharger 200 includes a main body 201 shaped to extend along the same direction as the tube to which is the compensate water discharger 200 is to be coupled and a collecting hole 204 formed in the top of the main body 201.

The main body 201 of the compensate water discharger 200 forms an airtight space closed at its bottom and sides to collect compensate water dropping through the collecting hole 204.

A discharging door 220 is formed in a side of the compensate water discharger 200 to discharge compensate water collected, and a solenoid valve 210 is provided to control the opening and closing the discharge door 220. The discharging door 220 may be opened or closed in the upper and lower or left and right directions by the solenoid valve 210. When the discharging door 220 is opened by the solenoid valve 210, compensate water collected may be discharged to the outside by the gravity.

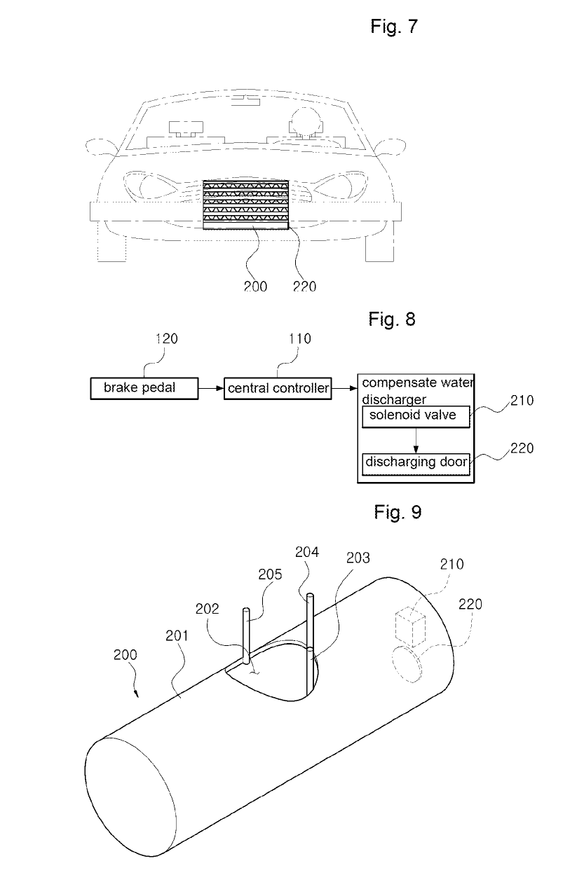

One side 201a of the compensate water discharger 200, which is coupled to the lowermost tube of the intercooler 200, may be positioned adjacent to the passenger seat of the car, and the opposite side 201b may be positioned adjacent to the driver's seat.

Where the left side 201a and the right side 20b of the main body 201 are placed adjacent to the passenger seat and the driver's seat, respectively, the discharging door 220 may be provided in the position facing the driver's seat in which case, if the bottom of the main body 201 is positioned parallel to the ground, the compensate water may naturally be rendered to flow to the discharging door 220 by the weight of the driver. (refer to, e.g., FIG. 7).

According to an embodiment of the present disclosure, compensate water inside the tube may drop, in a high volume, to the inside of the main body 201 through the collecting hole 202, or the compensate water may be scattered in tiny particles by the scattering rods 203 and 204, thereby reducing the likelihood of a high volume of compensate water coming into the engine 1. The compensate water collected in the main body 201 becomes bulky as collected more, and as the bonding among water molecules increases, the compensate water is less likely to return to the tube.

According to an embodiment of the present disclosure, the discharging door 220 may be opened or closed when the car stops acceleration because opening the discharging door 220 while the car accelerates may reduce the internal pressure of the tubes of the intercooler and resultantly the amount of high-pressure air supposed to come into the engine 1.

Thus, when the car stops acceleration, e.g., when the driver puts his food on the brake pedal, the discharging door 220 may be opened.

The solenoid valve 210 is connected with the controller 110 which corresponds to the ECU of the car. The opening and closing operations of the discharging door 220 are described below with reference to FIG. 6.

FIG. 6 is a view illustrating a compensate water discharger with a different shape according to an embodiment of the present disclosure. FIG. 7 is a view illustrating an example in which a discharging door of a compensate water discharger is positioned given the driver's seat, according to an embodiment of the present disclosure.

Referring to FIGS. 6 and 7, a side 201a of a compensate water discharger 200 coupled to the lowermost of the tubes of an intercooler is positioned adjacent to the passenger seat of the car, and the opposite side 201b of the compensate water discharger 200 is positioned adjacent to the driver's seat.

The bottom of the compensate water discharger 201 is shaped to be inclined to guide compensate water to the discharging door 220. For example, the main body 201 may be shaped so that the bottom of the main body 201 becomes deeper from the tube 2, to which the compensate water discharger 200 is coupled, as comes closer to the discharging door 220.

FIG. 8 is a block diagram illustrating a method for controlling a discharging door of a compensate water discharger according to an embodiment of the present disclosure.

The central controller 110 of the car may, in real-time, monitor whether the driver steps on the brake pedal 120, and when the brake pedal 120 is pressurized, the central controller 110 transmits a control signal to the solenoid valve 210 of the compensate water discharger 200.

Upon receiving the control signal from the central controller 110, the solenoid valve 210 opens the discharging door 220 of the compensate water discharger 200 to discharge compensate water collected to the outside.

When pressurization onto the brake pedal 120 is released or when a preset time elapses, the central controller 110 transmits a control signal to the solenoid valve 210 to close the discharging door 220. As such, the discharging door 220 may remain open when the brake pedal is stepped on or during the preset time. Thus, a time for discharging compensate water may be secured without deteriorating engine power output.

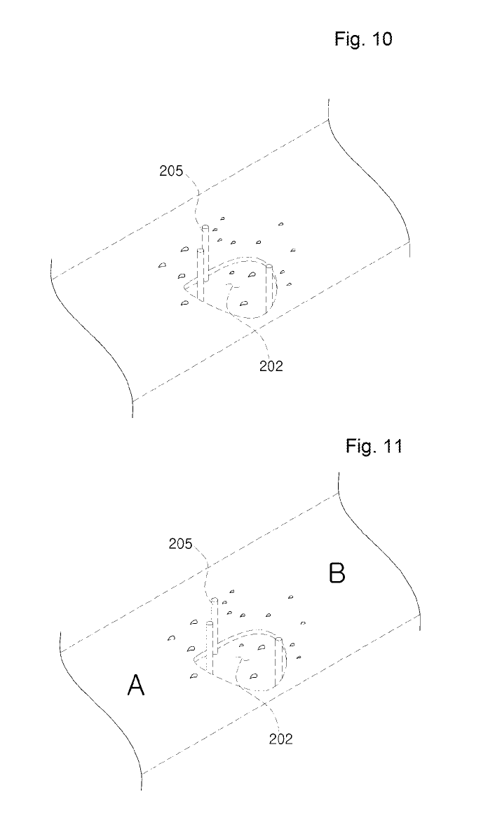

FIG. 9 is a perspective view illustrating a compensate water discharger according to an embodiment of the present disclosure. FIG. 10 is a view illustrating an example in which compensate water is scattered by scattering rods to reduce the likelihood of condensation, according to an embodiment of the present disclosure. FIG. 11 is a view illustrating an example in which scattering rods of a compensate water discharger are provided in different positions according to an embodiment of the present disclosure.

Although the main body 201 of the compensate water discharger 200 has a cylindrical shape in FIG. 9, the main body 201 is not limited to the shape and may rather be formed in other various shapes.

The air cooled while flowing through the tubes of the intercooler pass by at least one or more scattering rods 203, 204, and 205. The scattering rods may scatter cooled air or water vapor, thus reducing the likelihood of condensation into water.

Even when the cooled water is condensed into water while passing through the tubes, the compensate water may be dropped through the collecting hole 202 along the scattering rods 203, 204, and 205 to the inside of the main body 201 by the gravity.

According to an embodiment of the present disclosure, first, second, and third scattering rods 203, 204, and 205 are spaced apart from each other at a predetermined interval. The scattering rods 203, 204, and 205 may be coupled adjacent to the collecting hole 202 or onto the inner wall of the collecting hole 202.

The scattering rods 203, 204, and 205 may be attached onto the inner wall of the collecting hole 202 or the top of the main body 201. The positions of the scattering rods 203, 204, and 205 may be determined depending on the direction in which the air cooled by the intercooler moves.

For example, where the air cooled by the intercooler moves from position A to position B as shown in FIG. 11, the scattering rods arranged around the collecting hole 202 may be positioned closer to position A, which raises the chance of the compensate water contained in the cooled air being dropped to the inside of the collecting hole 202 after scattered by the scattering rods.

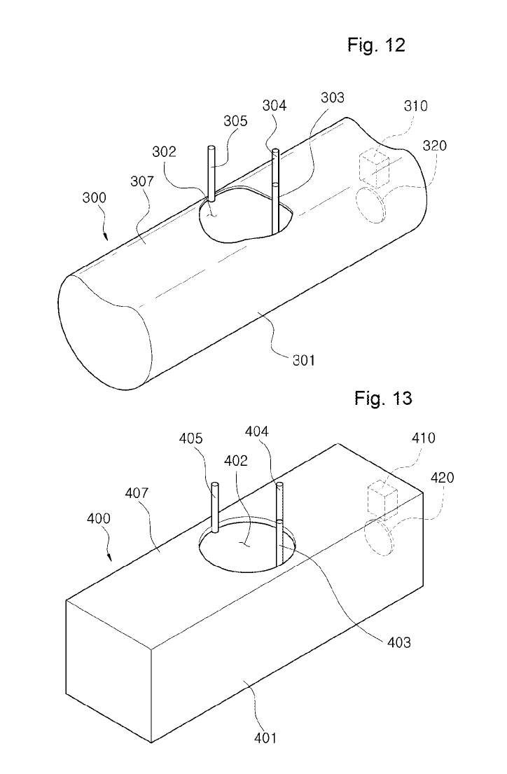

FIGS. 12, 13, and 14 illustrate main bodies with various shapes according to embodiments of the present disclosure.

Referring to FIG. 12, according to an embodiment of the present disclosure, a compensate water discharger 300 includes a main body 301 whose top is shaped to correspond to the bottom of a tube to which the compensate water discharger 300 is coupled.

The top of the compensate water discharger 300 may be depressed to correspond to the shape of the tube of the intercooler to which the compensate water discharger 300 is coupled, which facilitates the coupling or attachment of the compensate water discharger 300 to the tube of the intercooler.

Referring to FIG. 13, according to an embodiment of the present disclosure, a compensate water discharger 400 may be shaped as an elongate rectangular block in which case the bottom of the tube of the intercooler to which the compensate water discharger 400 is coupled may have a flat shape.

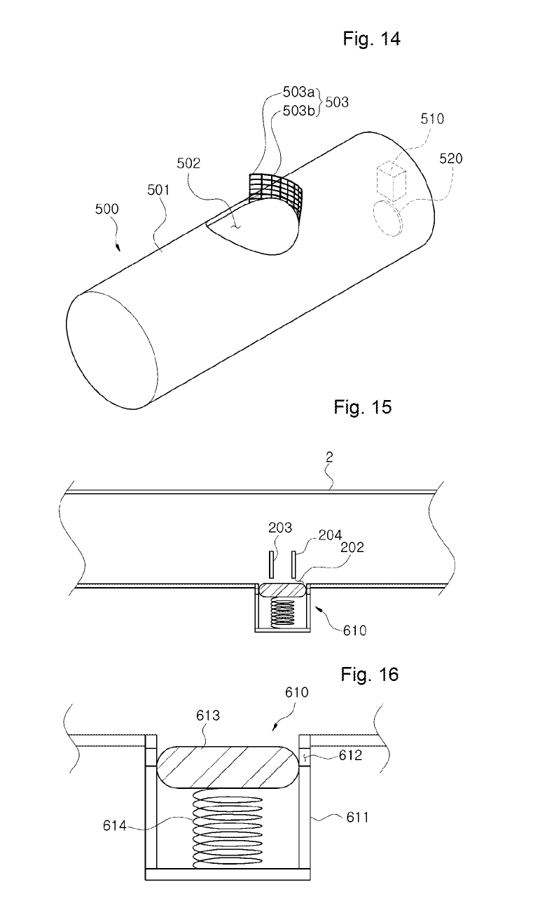

Referring to FIG. 14, according to an embodiment of the present disclosure, a compensate water discharger 500 may have a collecting hole 502 and a net 503 constituted of at least one or more vertical rods 503a and at least one or more horizontal rods 503b crossing the vertical rods 503a.

FIGS. 15, 16, 17, 18, 19, 20, 21, 22, 23, and 24 are views illustrating various examples of collecting compensate water when a main body of a compensate water discharger is formed as part of an intercooler according to embodiments of the present disclosure.

Referring to FIGS. 15 and 16, a discharging part 610 is formed in the bottom of the lowermost one 2 of the tubes of the intercooler.

A discharging hole 202 may be formed in a portion of the bottom of the tube 2 to form the discharging part 610. A first scattering rod 203 and a second scattering rod 204 are formed in the discharging hole 202 to scatter the water contained in the cooled air.

Referring to FIG. 16, the discharging part 610 includes a discharging head 613 formed to drop the compensate water gathered in the tube 2 by its own weight, an elastic member 614 allowing the discharging head 613 to move up or down, and a discharging body 611 receiving the elastic member 614 and the discharging head 613.

At least one or more discharging body holes 612 may be formed in the discharging body 611 to allow the compensate water gathered in the tube 2 to flow to the outside when the discharging head 613 is moved down by the weight of the compensate water.

The discharging body 611 may be formed to contact the outer edge of the discharging head 613, so that the discharging head 613 descends when the compensate water is gathered on the discharging head 613 in such an amount as to overcome the elastic force the elastic member 614. When the discharging head 613 descends a predetermined distance or more, the compensate water may be drained out through the discharging body holes 612 formed in the discharging body 611.

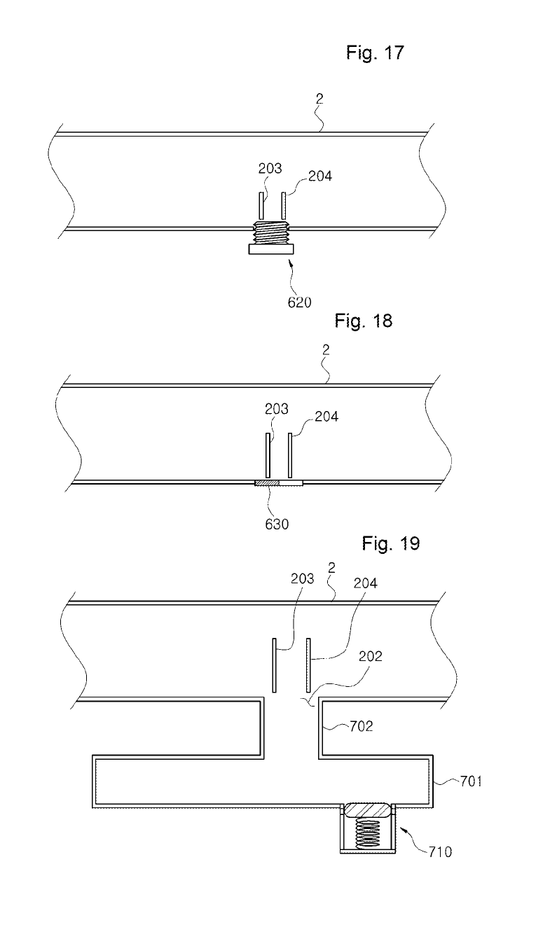

Referring to FIG. 17, at least one or more scattering rods 203 and 204 may be formed around the discharging hole 2 formed in the bottom of the tube 2, and a discharging bolt 620 may be provided to selectively open or close the discharging hole 2.

When the user releases the discharging bolt 620, the compensate water gathered in the tube 2 may be drained out through the discharging hole 2.

Referring to FIG. 18, at least one or more scattering rods 203 and 204 may be formed around the discharging hole 2 formed in the bottom of the tube 2. A valve 630 may be provided to selectively open or close the discharging hole 2. The valve 630 may be connected with the central controller 110 of the car, and when the brake pedal 120 is determined to be operated by the user, the valve 630 may be operated.

The valve 630 may be formed as a solenoid valve operated by an electrical signal. When the brake pedal 120 is operated, the valve 630 partially opens the discharging hole 2. In this case, when the car decelerates, the compensate water gathered in the tube 2 may be discharged out by the operation of the valve 630.

FIGS. 19, 20, and 21 illustrate an example in which a main body 701 of a compensate water discharger is coupled to the lowermost tube 2 of the intercooler. In this case, a tube connecting pipe 702 is formed to connect the tube 2 with the main body 701 of the compensate water discharger.

The embodiments of FIGS. 19 and 21 may be applicable to adding a compensate water discharger to a car with an intercooler.

As set forth above, the discharging hole 202 is formed in the lowermost tube 2 of the intercooler, and at least one or more scattering rods 203 and 204 are formed around the discharging hole 202.

The tube connecting pipe 702 is formed on the bottom of the discharging hole 202. Compensate water gathered moves to the main body 701. The main body 701 includes a discharging part 710 with a discharging head that may be moved up or down by the weight of compensate water. The configuration of the discharging part 710 has been described above in connection with FIG. 16.

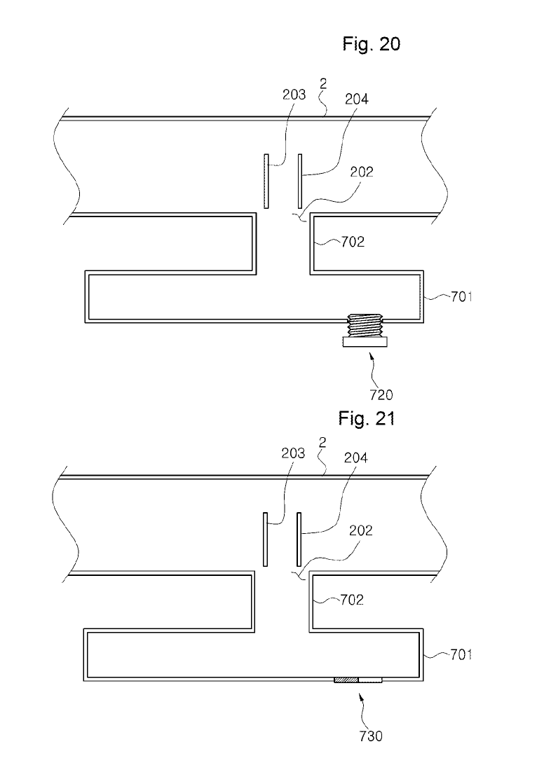

Referring to FIGS. 20 and 21, as set forth above, the main body 701 may include a discharging bolt 720 or a valve 730 operated by control signals from the central controller 110 of the car.

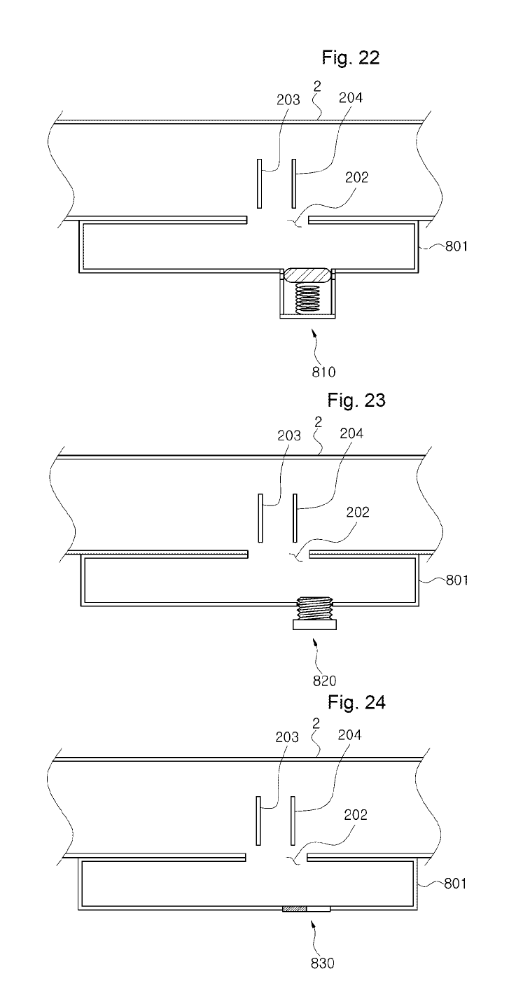

The embodiments of FIGS. 22 to 24 may be applied to cars with an intercooler, and the compensate water discharger may be manufactured simultaneously with the intercooler.

FIGS. 22, 23, and 24 illustrate an example in which a compensate water discharger 801 is integrally formed with an intercooler tube 2. The compensate water discharger 801 may include a discharging part 810 with a discharging head configured to move up or down, a discharging bolt 820, and a valve 830, as a structure to discharge compensate water.

According to the embodiments of the present disclosure, there may be a compensate water discharger attached to, or integrally formed with, an intercooler to easily discharge compensate water from the intercooler.

Embodiments of the present disclosure may prevent damage to the car intercooler due to condensation of water vapor in the intercooler tubes.

While the present disclosure has been shown and described with reference to exemplary embodiments thereof, it will be apparent to those of ordinary skill in the art that various changes in form and detail may be made thereto without departing from the spirit and scope of the present disclosure as defined by the following claims.

What is claimed is:

1. A compensate water discharger, comprising:
a man body coupled to a tube of an intercooler and configured to collect compensate water in the tube;
a collecting hole formed in an upper part of the main body and configured to provide a path along which the compensate water is collected from the tube to the main body;
a discharging door formed in a side of the main body to discharge the compensate water to an outside; and
a solenoid valve configured to open or close the discharging door.

2. The compensate water discharger of claim 1, wherein the tube of the intercooler is a lowermost one of a plurality of tubes of the intercooler.

3. The compensate water discharger of claim 1, wherein at least one or more scattering rods are connected to the collecting hole or the upper part of the main body and are positioned inside the tube.

4. The compensate water discharger of claim 3, wherein when the air moves from a first side of the collecting hole to a second side of the collecting hole, the at least one or more scattering rods are positioned closer to the first side of the collecting hole.

5. The compensate water discharger of claim 1, wherein a net is connected to the collecting hole or the upper part of the main body and is positioned inside the tube, and wherein the net includes at least one or more vertical rods and at least one or more horizontal rods crossing the at least one or more vertical rods.

6. The compensate water discharger of claim 1, wherein the upper part of the main body has a shape corresponding to a lower part of the tube.

7. An intercooler for a car, the intercooler comprising:
a plurality of tubes arranged one over another; and
a valve formed in a lowermost of the plurality of tubes to open or close, wherein the valve is controlled to open when a brake pedal of the car is operated.

8. The intercooler of claim 7, wherein a main body is coupled to the lowermost tube of the intercooler to collect compensate water passing through the valve.

9. The intercooler of claim 8, wherein a first side of the main body is positioned close to a passenger seat of the car, and a second side of the main body is positioned close to a driver's seat of the car, and wherein the main body becomes deeper from the first side to the second side of the main body.

10. The intercooler of claim 8, wherein the main body includes a discharging head configured to be moved up or down by the weight of the compensate water, an elastic member configured to move up or down the discharging head, and at least one hole configured to discharge the compensate water as the discharging head descends.
